(19) United States
(12) Patent Application Publication
(10) Pub. No.: US 2014/0272833 A1
(43) Pub. Date: Sep. 18, 2014

(54) METHOD AND SYSTEM FOR OPTIMAL CURRICULUM PLANNING AND DELIVERY

(71) Applicant: Accenture Global Services Limited, Dublin (IE)

(72) Inventors: Vipul A. GUPTA, Meerut (IN); Omesh SARAF, Mawana Road Meerut Cantt (IN)

(73) Assignee: Accenture Global Services Limited, Dublin (IE)

(21) Appl. No.: 14/208,667

(22) Filed: Mar. 13, 2014

(30) Foreign Application Priority Data
Mar. 15, 2013 (IN) 1141/CHE/2013

(51) Int. Cl. G09B 5/12

(52) U.S. Cl. CPC G09B 5/12
USPC 434/219

(57) ABSTRACT

Methods and systems are disclosed for planning and delivering curricula and specifically for managing learning and development in organizations. In some embodiments, a method for conducting training in an organization comprises identifying a candidate project in the organization, wherein identifying the candidate project includes determining that the candidate project is at risk and that a level of training for the candidate project is below a training threshold conducting, by one or more processors, a marginal benefit analysis including determining a marginal success rate increase as a function of a training level increase; conducting, by the one or more processors, a learning effectiveness analysis including determining a plurality of effectiveness scores and a plurality of cost values corresponding to a plurality of training courses; and determining a training plan for an employee of the organization based on the marginal benefit analysis and the learning effectiveness analysis.

### CROSS-REFERENCE TO RELATED APPLICATION

This application claims the benefit of Indian Application No. 1141/CHE/2013, filed Mar. 15, 2013, which is herein incorporated by reference in its entirety.

### TECHNICAL FIELD

The present disclosure relates generally to methods and systems for planning and delivering curricula and specifically for managing learning and development in organizations.

### BACKGROUND

In today's dynamic business environment, customer needs and behaviors are changing at a rapid pace. In such an environment and to meet the ever changing needs of the customers, an organization should be agile and have a continuous focus on developing the capabilities of its workforce. On the other hand, organizations must also be very cost conscious to stay competitive. Investment in learning and development (LSD) can take a large portion of the organization's budget. In the past, companies addressed L&D using various “one size fits all” approaches. These approaches often consisted of requiring every employee to take a set amount of training (e.g., 10 hours) in a set period (e.g., a quarter). Such approaches often proved costly and ineffective. It is therefore desirable to provide L&D systems and methods which are consistent with the needs of the organization and type of work, on one hand, and the potential benefits of training courses, on the other hand.

In some embodiments, a method for conducting training in an organization comprises identifying a candidate project in the organization, wherein identifying the candidate project includes determining that the candidate project is at risk and that a level of training for the candidate project is below a training threshold; conducting, by one or more processors, a marginal benefit analysis including determining a marginal success rate increase as a function of a training level increase; conducting, by the one or more processors, a learning effectiveness analysis including determining a plurality of effectiveness scores and a plurality of cost values corresponding to a plurality of training courses; and determining a training plan for an employee of the organization based on the marginal benefit analysis and the learning effectiveness analysis.

According to some embodiments, the method further comprises determining the training threshold including collecting success rates of a plurality of prior projects; collecting a plurality of training levels at the prior projects; and analyzing a correlation between the success rates and the training levels, wherein for a subset of the plurality of prior projects with training levels below the training threshold, the corresponding success rates are below a success threshold. In some embodiments, identifying the candidate project further comprises determining that a residual life of the candidate project is above a minimum residual life.

In some embodiments, determining an effectiveness score for a training course comprises determining an impact of the training course on at least one of employee performance, employee proficiency level, employee retention, employee promotion, employee utilization, employee satisfaction, or project success. In some embodiments, determining the training plan for the employee comprises selecting a training course for the employee, wherein the training course has a high effectiveness score and the training course has not been previously taken by the employee. In some embodiments, determining the training plan for the employee comprises selecting a training course that is consistent with prior training courses taken by the employee, in some embodiments, the training plan for the employee is one of one or more training plans, and wherein implementing the one or more training plans results the level of training for the candidate project to increase above the training threshold.

In some embodiments, the method further comprises determining training plans for a plurality of employees of the organization, wherein determining the training plans includes selecting a plurality of training courses based on learning effectiveness scores and wherein the marginal benefit analysis indicates that adding the plurality of training courses results in a specified marginal success rate increase.

In some embodiments, a learning management system configured to conduct training in an organization comprises one or more nontransitory storage media configured to store a level of training for a project in the organization; and one or more processors configured to implement an analytics engine, wherein the analytics engine is configured to identify the project as a candidate project, wherein identifying the candidate project includes determining that the candidate project is at risk and that a level of training for the candidate project is below a training threshold; conduct a marginal benefit analysis including determining a marginal success rate increase as a function of a training level increase; conduct a learning effectiveness analysis including determining a plurality of effectiveness scores and a plurality of cost values corresponding to a plurality of training courses; and determine a training plan for an employee of the organization based on the marginal benefit analysis and the learning effectiveness analysis.

In some embodiments, a nontransitory computer readable medium stores a computer program, wherein the computer program, when executed by one or more computers, causes the one or more computers to perform a method for conducting training in an organization, the method comprising identifying a candidate project in the organization, wherein identifying the candidate project includes determining that the candidate project is at risk and that a level of training for the candidate project is below a training threshold; conducting, by one or more processors, a marginal benefit analysis including determining a marginal success rate increase as a function of a training level increase; conducting, by the one or more processors, a learning effectiveness analysis including determining a plurality of effectiveness scores and a plurality of cost values corresponding to a plurality of training courses; and determining a training plan for an employee of the organization based on the marginal benefit analysis and the learning effectiveness analysis.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 is a block diagram of a learning management system consistent with some embodiments.

FIG. 2 is a flowchart of a learning management method consistent with some embodiments.

FIG. 3 is a flowchart of a project analysis method consistent with some embodiments.

FIG. 4 is an exemplary success rate analysis chart set consistent with an embodiment.

FIGS. 5A and 5B are exemplary live project analysis graphs consistent with some embodiments.

FIG. 6 is a flowchart of an investment optimization method using marginal benefit analysis consistent with some embodiments.

FIG. 7 is a flowchart of a training enhancement analysis method consistent with some embodiments.

FIG. 8 shows an exemplary chart set including graphs of incremental success rate increases consistent with an embodiment.

FIG. 9 shows an exemplary chart set for illustrating marginal benefit analysis consistent with some embodiments.

FIG. 10 shows a flowchart of a selection method based on the ROI consistent with some embodiments.

FIG. 11 shows an exemplary scorecard chart for courses consistent with an embodiment.

FIG. 12 is a flowchart of a method for employee course recommendation according to some embodiments.

FIGS. 13A-13C show a block diagram of the learning management system according to some embodiments.

### DETAILED DESCRIPTION

The following detailed description refers to the accompanying drawings. Wherever possible, the same reference numbers are used in the drawings and the description to refer to the same or similar parts. Also, similarly-named elements may perform similar functions and may be similarly designed, unless specified otherwise. While several exemplary embodiments and features are described here, modifications, adaptations, and other implementations may be possible, without departing from the spirit and scope of the invention. Accordingly, unless stated otherwise, the descriptions relate to or more embodiments and should not be construed to limit the invention as a whole. Instead, the proper scope of the invention is defined by the appended claims.

Different projects progress at different paces. Also, some projects fail while others succeed. These differences are often attributed to the capabilities and synergies of the people involved in each project. Delivering a project as per plan largely relies on execution capabilities of the team members who execute the project. These capabilities and synergies may often be enhanced by choosing the correct training plans for the team members.

Various embodiments of the present disclosure provide systematic approaches to L&D. These approaches include analyzing and quantifying the organizational or project needs, the available courses and their potential effect on a project, and the capabilities and interests of employees in a project. Some embodiments choose a targeted approach to prioritize L&D investment in order to improve business profitability. Some embodiments utilize a learning management system for performing the analysis and delivering training plans at different levels such as project level, training category level, and employee level. In various embodiments, the learning management system identifies the benefits of training and its contribution to the success of projects. The system may also quantify the cost and return of training courses or categories of training courses and, accordingly, rank the various training courses based on their return on investment. The system may also propose individualized training plans for one or more employees based on their needs or interest and also based on the general requirements of their projects or organization.

FIG. 1 is a block diagram of a learning management system 100 according to some embodiments. System 100 includes a database 110, an analytics engine 120, a reporting engine 130, and a network system 140. Database 110 stores data such as information about prior or present projects and training courses. Analytics engine 120 receives and analyzes information related to various projects and training courses. In some embodiments, the analytics engine is also a mapping engine, which maps different types of data by finding relationships among them. Reporting engine 130 reports the results of the analysis to users. Network system 140 enables different parts of the system to communicate with each other and with external users or systems. More details about these parts and their functions are described below.

FIG. 2 is a flowchart of a learning management method 200 according to some embodiments. In various embodiments, different steps of method 200 are performed by the learning management system or some parts of that system. The ensuing figures and their detailed description describe the steps of method 200 in more detail.

In block 202, the system analyzes prior or ongoing projects. By analyzing prior projects that have already completed, with either success or failure, the system may determine correlations between different factors such as training level and project success. The system may also analyze the ongoing (live) projects to determine various aspects of their status such as their progress with respect to their goals, their existing training level, or their remaining life time.

In block 204, the system uses the results of the project analyses to identify one or more projects as candidates that may benefit from improvement in their training levels. In particular, the system may use the derived correlation between training levels and project success, an identification of live projects that are at risk, and the status of those projects.

In block 206, the system conducts a marginal benefit analysis. This analysis may predict a relationship between an increase in the training level in a candidate project and an increase in the probability of success of that project.

In block 208, the system performs a learning effectiveness analysis. This analysis determines effectiveness scores for one or more training courses. This analysis may also estimate the cost of the training courses and the financial return of the training courses. Based on the results, the system may derive return on investment (ROI) values for one or more training courses. Moreover, the system may determine a prioritized list of training courses.

In block 210, the system generates training plans for one or more employees of the organization. The training plans may include recommendations for an employee to take one or more training courses. To generate a training plan, the system utilizes the results of the marginal benefit analysis and the learning effectiveness analysis. Moreover, the system may utilize the training history of the employees.

In some embodiments, the system analyzes one or more prior (closed) projects to determine correlations between training levels and project success. The system may apply the correlation to identify candidate projects from among the live projects. FIG. 3 is a flowchart of a project analysis method 300 according to some embodiments. In various embodiments, different steps of method 300 are performed by the learning management system or some parts of that system, such as the analytics engine in interaction with the database.

In block 302, the system analyzes data from closed projects, that is, projects that have already ended. In some embodiments, the system analyzes the data about the training courses that were offered to or taken by the employees as part of a closed project. A training course may be a course that is offered to the employees of the organization. Such a course may be offered in one or more of different settings, such as a class setting, an online setting, or a virtual setting. In some embodiments, to analyze the data, the system first assigns various training courses to different training categories. The training categories may include, for example, soft skills (such as communications, people management, or business etiquette), industry skills (such as retail or other skills related to the industry, e.g., oil and gas extraction skills in the oil industry), technical skills (such as computer programming or software usage) and functional skills (such as negotiations, data analytics, or process knowledge).

In block 302, the system may also derive the outcome of a closed project. The outcome may indicate whether the project succeeded or failed in reaching its goals. The system may also derive the training penetration for one or more of the closed or live projects. A training penetration is the percentage of the employees in a project who take a specific training course, any course from a category, or from any category. For example, if thirty percent of the employees in a project take a specific training course, the penetration rate for that training course in that project is 30%. In various embodiments, for one or more projects the penetration rate is aggregated for all training courses or for all courses in a training category. For example, if for a project the penetration for technical training courses is 20%, this penetration indicates that twenty percent of the employees in that project have taken one of the training courses that fall under the technical category and relate to that project.

In block 304, the system derives some relations between training and success. In particular, the system may use the data about the closed projects to derive correlations between training penetrations and success rates of projects. The system may find projects for which the training penetration fell in a specific range and determine the success rate for those projects as the ratio of successful projects to total projects.

FIG. 4 is an exemplary success rate analysis chart set 400 according to an embodiment. Chart set 400 illustrates relationships among training penetration, success rate, and training frequency for an exemplary set of closed projects. Chart set 400 includes an abscissa axis 401 for training penetration rates, a first ordinate axis 402 for success rates, and a second ordinate axis 404 for frequencies. Chart set 400 also includes frequency bars 405-407 and a success rate graph 410. In various embodiments, penetration rates on axis 401 represent the values of penetration rates for an aggregation of all training courses, those in a specific training category, or a specific training courses. In FIG. 4, the penetration rates of the analyzed projects are grouped into three different ranges, as marked on abscissa 401. The three ranges are penetration rates below 7%, those between 7% and 17%, and those above 17%. The ratio of projects that fall into each group are shown in frequency bars 405-407, the values of which are determined by projection onto second ordinate axis 404. Further, the aggregate success rate for each group is shown by points on graph 410, the values of which are determined by projection onto first ordinate axis 402.

In particular, in chart set 400, bar 405 indicates that of the analyzed projects, 50% belonged to the first group, that is, they had a training penetration rate below 7%. Moreover, the leftmost point on graph 410 indicates that for this group, the average success rate was 56%. Bar 406 and the middle point on graph 401, on the other hand, indicate that 30% of the projects had a penetration rate between 7% and 17% and for them the average success rate was 76%. Finally, bar 407 and the rightmost point on graph 410 indicate that 20% of the projects had a penetration rate above 17% and an average success rate of 82%. Further, as indicated at the bottom of chart set 400, the average success rate for all projects was 67%.

In some embodiments, the system uses the correlations between the success rates and the training levels to determine one or more training thresholds. For example, the system may determine that for a live project, an acceptable chance for success is above 75%. The chance of success for a live project can be predicted based on success rates of closed projects. To achieve that chance and based on graph 410, the system may decide that the training penetration should be above 17%. Thus, the system may determine that, for the type of training analyzed in chart set 400, the training threshold is 17%. That is, for a project to have a chance of success above 75%, its training penetration should be above 17%.

Returning to FIG. 3, in block 306, the system derives characteristics of one or more live projects. The characteristics may include the progress of the project with respect to its goals or the time remaining until the scheduled end of the project (residual life). Based on these characteristics, the system may determine one or more live projects that are at risk, that is, have a low chance of meeting their goals. In various embodiments, such a low chance may be defined based on the nature of the project and may have values such as below 5% or below 75%. The characteristics of a live project may also include the up-to-date penetration rate thr some training courses, training categories, or all training courses related to the project.

The system may use the analyses of the past and present projects to find some at risk projects that may be salvaged. In block 308, the system compares the derived characteristics of one or more live projects with some historical data. In particular, in some embodiments, the system analyzes a subset of live projects that, as determined in block 306, have a high risk of failing. For those projects, the system may compare the training penetrations with the training thresholds. In some embodiments, for each live project, the system determines the number of training categories or training courses for which the penetration rate is below the corresponding threshold penetration. Moreover, the system may further consider the residual life of each project to determine the candidate projects.

FIG. 5A is an exemplary live project analysis graph 500 according to some embodiments. Graph 500 includes an abscissa axis 502 for residual life and an ordinate axis 504 for number of learning variables that are below threshold. In graph 500, each live project is represented by a blob in the graph's coordinate system, which also has a size that is proportional to the size of the project (defined by, e.g., the size of the resources or goals), and a gray scaled color that is related to the level of risk, that is, the probability that the project will miss its goals. In particular, the darker blobs face higher risks. In some embodiments, the number of learning variables is related to the number of training courses related to the project. Further, in some embodiments, the level of risk can take two or more values, such as low, medium, and high. In various embodiments, these levels are defined based on the nature of the project or the organization. In an embodiment, for example, low, medium, and high risks correspond to risk values that are, respectfully, below 25%, between 25% and 50%, and above 50%. In graph 500, blob 510, for example, is a black blob with coordinates 20 and 13 on the two axes. Thus, the live project that corresponds to blob 510 is a project with a high risk of failure, which has 20 months of residual life and 13 training courses with penetrations that are below their training thresholds.

Returning to FIG. 3, in block 310, the system uses the results of the analysis of live projects to select one or more candidate projects. In some embodiments, a candidate project is an at risk project that may be salvaged through improved training plans. In some embodiments, the system may select such a candidate from among candidates with high or medium risks of failure for which the residual life and number of below threshold variables are large enough such that an improved training plan may be effective.

An example of such selection is shown in FIG. 5B. In FIG. 5B, the axes and data are similar to those shown and described in FIG. 5A. In FIG. 58, the system has selected eight projects, contained in box 560, as candidate projects. Here, each of the candidate projects faces a high or a medium risk of failure (indicated by a black or a dark gray color, respectively). Moreover, each of the candidate projects has at least 15 months of residual life and at least four learning variables that are below threshold. In this example, the system selects these projects as candidates, based on the condition that for a change in training plan to be effective, at least fifteen months are needed and that such a change is not required for projects with less than four learning variables below threshold.

In various embodiments, to change the training plan in a candidate project, the system determines by what amount should the training penetration increase for a project, which training course should be included for increasing the training level, or which employees should take which training course. In some embodiments, to determine the necessary increase in training levels or penetrations, the system performs a marginal benefit analysis. In various embodiments, a marginal benefit analysis determines the probability of increase in success rate or net revenue of a project resulting from a marginal increase the training as a whole or in one or more categories.

FIG. 6 is a flowchart of an investment optimization method 600 using marginal benefit analysis according to some embodiments. In various embodiments, different steps of method 600 are performed by the learning management system or some parts of that system, such as the analytics engine in interaction with the database.

In block 602, the system performs a success rate analysis by quantifying the relationship between probability of project success and training level. The system may find the relationship by analyzing the historical data of closed projects, their training levels, and the success rates.

In block 604, the system analyzes the incremental benefit of training increase. In some embodiments, this incremental benefit is determined by deriving the potential benefits flowing from the increase after deducing the cost of the increase.

In block 606, the system determines priorities of different types of training courses or categories. The priorities may depend on various factors, such as nature of project, location of the project, budget of the project, or other constraints. In block 608, the system finds the optimized investment plan to enable the project to meet its goals.

Based on the analysis, the system may propose training enhancement for one or more projects. FIG. 7 is a flowchart of such a training enhancement analysis method according to some embodiments. In block 702, the system chooses a statistical model to predict probability of success based on penetration rates of different categories of training courses, such as functional, technical, soft skills and industry. The model is chosen based on the type and volume of training and success data. Probability of success for an individual training category is derived using univariate models, while multivariate models are chosen for different combinations of training categories.

In block 704, the system scores the chosen model against data derived from projects that have already closed. In some embodiments, the system uses the data on whether each closed project succeeded or failed. The system also uses the penetration rate for the close projects for all training courses or various categories of training courses. If the model is a parametric model the system may use the data to determine the values of the parameters.

In block 706 the system uses the model to perform an incremental success analysis. In some embodiments, the system determines the increase in success rate of a project based on penetration rate in one more training courses or training categories. The system may, for example, determine the increase in success rate if the penetration rate for each of the training categories increases while the penetration rates of other training categories are kept fixed. In various embodiments, for a live project, the system considers the penetration rate to increase from its existing level in the project. In some embodiments, the system performs the success rate analysis of method 700 for one or more candidate projects.

FIG. 8 shows an exemplary chart set 800 including graphs of incremental success rate increases according to an embodiment. In chart set 800, the abscissa axis 802 denotes increase in penetration rates of various training categories and the ordinate axis 804 denotes the resulting incremental increase in success rate for an exemplary project. Chart set 800 includes four graphs showing incremental increase in the success rate as a function of the increase in penetration rate in four training categories. In particular, graphs 810, 820, 830, and 840 show the incremental increases as functions of increase in penetration rates in the categories of industrial, soft skills, technical, and functional training courses, respectively. As demonstrated by the broken lines, graphs 810 and 820, for example, indicate that to increase the success rate of the project by 10%, the penetration rate for industrial training courses should be increased by about 38% or the penetration for soft skills training courses should be increased by about 45%.

Returning to FIG. 7, in block 708 the system performs marginal benefit analysis according to some embodiments. In some embodiments, the system performs a cost and return analysis for training. The system may first use the results of incremental success analysis to determine how much should the penetration increase for one or more training courses, categories, or overall training to achieve a desired success rate for a project. The system may also determine the amount of training that results in the desired penetration and the cost of providing that amount of training. In some cases, such costs result in an increase in the budget allocated to training. The system may further determine the financial return of achieving the resulting success rate. In some embodiments, this return is the net profit of the project succeeds multiplied by the success probability derived from the achieved success rate. The system may then determine the net impact of the increase in training budget by subtracting the cost from the financial return.

FIG. 9 shows an exemplary chart set 900 including four graphs for illustrating marginal benefit analyses according to some embodiments. In chart set 900, the abscissa axis 902 denotes penetration rates of various training categories and the ordinate axis 904 denotes the resulting marginal benefit for an exemplary project, depicted in millions of dollars. Chart set 900 includes four graphs 910, 920, 930, and 940, showing marginal benefits as functions of penetration rates in four training categories, i.e., industrial, soft skills, functional, and technical training courses, respectively. Graph 910, for example, indicates that in this exemplary embodiment, increasing the penetration rate for industrial training courses from 1% to about 23% should result in a steady increase in the marginal benefit from about $180M to about $212M; and that increasing the penetration rate of this category above 23% would not result in a noticeable increase in marginal benefit. Similarly, graphs 920, 930, and 940 respectively indicate that similar steady increases result, albeit at successively slower rates, if the penetration rate for the soft skills, functional, and technical training courses are increased from 0% to about 46%, 55%, and 67%, respectively.

Returning to FIG. 7, in block 710 the system considers the marginal benefit analyses for one or more training categories or courses, and accordingly decides a training plan. The system may, for example, choose one or more projects for implementing a training enhancement. In various embodiments, the system chooses these projects as projects for which the net positive impact is highest, or the ratio of impact to the budget increase is the highest, or the budget increase is consistent with budgetary limits of the projects. In some embodiments, the training enhancement includes determining that training should be increased by some percentage for all or a group of training courses.

In some embodiments, different training courses are analyzed to determine which one should be included in a training enhancement for a project. FIG. 10 shows a flowchart of a method 1000 for selecting one or more training courses based on the return on investment (ROI) for each, according to some embodiments. In various embodiments, different steps of method 1000 are performed by the learning management system or some parts of that system, such as the analytics engine in interaction with the database.

In block 1002, the system identifies an impact area for one or more training courses. In various embodiments, an impact area may be related to factors that affect the performance of an employee or a project. In some embodiments, the set of impact areas could include one or more of employee satisfaction, attrition, promotion rate, performance, work success, or the cost per employee for a particular training.

In block 1004, the system determines the effect of a training course on one or more impact areas. In some embodiments, the system determines this effect by deriving for a training course a score in the one or more impact areas. In some embodiments, the score can be chosen from a graduated scale, such as low, medium, and high. In some embodiments, some of the scores are based on performance, feedback, or assessment of employees that have taken that course in the past. In some embodiments, the scores are determined by comparing a performance factor, such as attrition or promotion rate, between a group of employees that have taken the course and another group that have not, as a control group.

FIG. 11 shows an exemplary scorecard chart 1100 for a number of exemplary training courses in a set of impact areas according to an embodiment. The first column in chart 1100 lists the name of the training courses. The second to seventh columns respectively show the relative scores of a training course in terms of employee satisfaction, reduction in attrition rate, increase in promotion rate, payroll and non-payroll cost per employee, increase in performance ratings, and business impact of the trainings. Each cell in chart 1100 determines the corresponding scores in a grayscale code. Lighter shades of the grayscale indicate lower score of the training on a parameter while darker shades indicate higher score. The eighth column indicates the average of the scores for the impact areas and quantifies it as an effectiveness score. The ninth column shows the relative rank for the cost of a training course, with a higher rank value indicating a higher cost.

Returning to FIG. 10, in block 1006, the system calculates the cost of training course. In some embodiments, the cost is calculated for one employee. In block 1008, the system determines the ROI of each training course and ranks the courses based on their ROIs. In some embodiments, the ROI is quantified via normalizing the cost of each course by its impact. In some embodiment, this normalization is performed via dividing the cost by the effectiveness score. A lower normalized cost, therefore, indicates a lower cost for improving the effectiveness score by one unit, and thus a higher ROI. In FIG. 11, for example, the last column in chart 1100 lists the rank of each course in terms of its normalized cost as compared to other listed courses.

In various embodiments, the system may perform the marginal benefit analysis before and after the learning effectiveness analysis. In some embodiments the system may use the results of the marginal benefit analysis in the learning effectiveness analysis. In particular, the system may find the ROI of one or more training courses when their penetrations have increased by the amount derived from the marginal benefit analysis. Alternatively, the system may first perform the ROI analysis to find the highest ranking courses or course categories, and then find the marginal benefit for those top ranking courses or categories.

In various embodiments, the system uses the large-scale analysis of the training enhancement plan and the more detailed ROI analysis of the courses to determine a training plan for one or more employees involved in a project. FIG. 12 is a flowchart of a method 1200 for an employee course recommendation according to some embodiments.

In block 1202, the system identifies one or more training courses or categories that apply to the project. In some embodiments, the training courses or categories depend on the nature or goals of the project, employee roles, or type of client. A project may require specific courses and in specific areas that relate to the goals of the project. For example, the project that heavily utilizes computer technology may require courses in the technical areas such as hardware or software technologies, while a drug development project may require courses in the technical areas such as pharmaceutics. Similarly, employees in sales roles may require courses in soft skills areas such as verbal and written communication, as well as functional areas such as negotiations. In addition, employees may require courses in industry areas such as retail or banking depending on the type of client or nature of work.

In block 1204, of the identified courses the system selects courses that have a desirable ROI. In some embodiments, for example, the system ranks the courses in one or more categories by their ROI and starts by selecting courses that have a higher ROI.

In block 1206, the system attempts to find the right employees for taking a course or the right course to be taken by an employee. To that end, the system may analyze the training history of one or more employees working in the project. This history may indicate that an employee has already taken a course and thus may not take it again; or may indicate that the work profile of an employee does not require taking courses in a specific category, and thus that employee will most possibly not benefit from taking a course in that category.

In block 1208, the system uses the rank of a course and the training history of an employee to recommend a course for the employee. In some embodiments, the system recommends a course for an employee based one or more factors that may include the high ROI of the course, that the course fits into a category of courses needed for the project, that the employee has not previously taken the course, or that the course fits the specialty, the rank, the interests, or the function of the employee. In making the recommendations, the system may also consider whether an aggregation of all recommended courses fits the training enhancement plan devised for the project.

FIGS. 13A-13C show an additional block diagram of the learning management system according to some embodiments. As shown in FIG. 13A, the system may include multiple databases 1302 that receive, store, and provide to the analytics and mapping engine different types of data. The databases may include a project information database, a financial database, a time and activity database, a training instance database, an employee demographics database, an employee travel database, and an employee rewards and recognition (R&R) database.

Based on data in these databases, analytics and mapping engine 1310 generates multiple types of analyses and maps 1312. The analyses include an analysis of the financial performance of projects by division. The maps show correlations, based on historical or current data, between employees on the one hand, and projects, training courses, demographics, travel, or rewards, on the other hand.

The system uses the analyses and maps to divide the historical data into those related to successful projects and those related to unsuccessful projects, and the teams that have historically worked on each type of project. For the groups of teams, the system generates data files 1314, which include data related to the composition of the teams, new joiners, promotions, leadership span, training level, travel plans, rewards and recognitions, chargeability, global delivery, diversity, and gender composition.

Based on the generated data files, analytics engine 1310 derives the effectiveness of various factors in project success (1316), and if the factors are actionable, ranks them based on their ROIs (1318). Based the high ROI factors and the employee training maps, the system categorizes the training courses into different categories (1320) and derives the training level of different teams by the training category and variable (1322). Based on these data, the financial analyses data, and the employee-project mappings, analytics engine 1310 derives, for each training category, the impact of learning on success of a project (1324). The system uses these data to derive training thresholds by category and variable (1326).

Analytics engine 1310 applies training thresholds to find candidate projects from among live projects that are missing financial and training targets (1328). Reporting engine 1330 reports the results (1332) to the users. Results 1332 include, for example, contract-level and employee-level reports that identify areas of risk and propose prioritized training courses for employees in a project or individualized training plans.

In some embodiments, one or more of the disclosed engines are implemented via one or more computer processors executing software programs for performing the functionality of the corresponding engines. In some embodiments, one or more of the disclosed engines are implemented via one or more hardware modules executing firmware for performing the functionality of the corresponding engines. In some embodiments, one or more of the disclosed engines include storage media for storing data or databases used by the engine, or software or firmware programs executed by the engine. In some embodiments, one or more of the disclosed engine or disclosed storage media are internal or external to the disclosed systems. In some embodiments, one or more of the disclosed engines or storage media are implemented via a computing “cloud,” to which the disclosed system connects via a communication system and accordingly uses the external engine or storage medium. In some embodiments, the disclosed storage media for storing information include non-transitory computer-readable media, such as a CD-ROM, a computer storage, e.g., a hard disk, or a flash memory. Further, in some embodiments, one or more of the storage media are non-transitory computer-readable media that store information or software programs executed by various engines or implementing various methods or flowcharts disclosed herein.

The foregoing description of the invention, along with its associated embodiments, have been presented for purposes of illustration only. They are not exhaustive and do not limit the invention to the precise form disclosed. Those skilled in the art will appreciate from the foregoing description that modifications and variations are possible in light of the above teachings or may be acquired from practicing the invention. For example, the steps described need not be performed in the same sequence discussed or with the same degree of separation. Likewise various steps may be omitted, repeated, or combined, as necessary, to achieve the same or similar objectives. Similarly, the systems described need not necessarily include all parts described in the embodiments, and may also include other parts not described in the embodiments. Accordingly, the invention is not limited to the above-described embodiments, but instead is defined by the appended claims in light of their full scope of equivalents.

We claim:

1. A computer-implemented method for conducting training in an organization, the method comprising:
identifying, by one or more processors, a candidate project in the organization, wherein identifying the candidate project includes determining that the candidate project is at risk and that a level of training for the candidate project is below a training threshold;
conducting, by the one or more processors, a marginal benefit analysis including determining a marginal success rate increase as a function of a training level increase;
conducting, by the one or more processors, a learning effectiveness analysis including determining a plurality of effectiveness scores and a plurality of cost values corresponding to a plurality of training courses;
determining, by the one or more processors, a training plan for an employee of the organization based on the marginal benefit analysis and the learning effectiveness analysis; and
delivering, by the one or more processors, the training plan.

2. The method of claim 1, further comprising determining the training threshold comprising:
collecting success rates of a plurality of prior projects;
collecting a plurality of training levels at the prior projects; and
analyzing a correlation between the success rates and the training levels, wherein for a subset of the plurality of prior projects with training levels below the training threshold, the corresponding success rates are below a success threshold.

3. The method of claim 1, wherein identifying the candidate project further comprises determining that a residual life of the candidate project is above a minimum residual life.

4. The method of claim 1, wherein determining an effectiveness score for a training course comprises determining an impact of the training course on at least one of employee performance, employee proficiency level, employee retention, employee promotion, employee utilization, employee satisfaction, or project success.

5. The method of claim 1, wherein determining the training plan for the employee comprises selecting a training course for the employee, wherein the training course has a high effectiveness score and the training course has not been previously taken by the employee.

6. The method of claim 1, wherein determining the training plan for the employee comprises selecting a training course that is consistent with prior training courses taken by the employee.

7. The method of claim 1, wherein the training plan for the employee is one of one or more training plans, and wherein implementing the one or more training plans causes the level of training for the candidate project to increase above the training threshold.

8. The method of claim 1, further comprising determining training plans for a plurality of employees of the organization, wherein determining the training plans includes selecting a plurality of training courses based on learning effectiveness scores and wherein the marginal benefit analysis indicates that adding the plurality of training courses results in a specified marginal success rate increase.

9. A learning management system configured to conduct training in an organization, the system comprising:
one or more nontransitory storage media configured to store a level of training for a project in the organization; and
one or more processors coupled to the one or more storage media, configured to implement an analytics engine, wherein the analytics engine is configured to:
identify the project as a candidate project, wherein identifying the candidate project includes determining that the candidate project is at risk and that a level of training for the candidate project is below a training threshold;
conduct a marginal benefit analysis including determining a marginal success rate increase as a function of a training level increase;
conduct a learning effectiveness analysis including determining a plurality of effectiveness scores and a plurality of cost values corresponding to a plurality of training courses;
determine a training plan for an employee of the organization based on the marginal benefit analysis and the learning effectiveness analysis; and
deliver the training plan.

10. The learning management system of claim 9, wherein the analytics engine is further configured to determine the training threshold comprising:
collecting success rates of a plurality of prior projects;
collecting a plurality of training levels at the prior projects; and
analyzing a correlation between the success rates and the training levels, wherein for a subset of the plurality of prior projects with training levels below the training threshold, the corresponding success rates are below a success threshold.

11. The learning management system of claim 9, wherein identifying the candidate project further comprises determining that a residual life of the candidate project is above a minimum residual life.

12. The learning management system of claim 9, wherein determining an effectiveness score for a training course comprises determining an impact of the training course on at least one of employee performance, employee proficiency level, employee retention, employee promotion, employee utilization, employee satisfaction, or project success.

13. The learning management system of claim 9, wherein determining the training plan for the employee comprises selecting a training course for the employee, wherein the training course has a high effectiveness score and the training course has not been previously taken by the employee.

14. The learning management system of claim 9, wherein determining the training plan for the employee comprises selecting a training course that is consistent with prior training courses taken by the employee.

15. The learning management system of claim 9, wherein the training plan for the employee is one of one or more training plans, and wherein implementing the one or more training plans causes the level of training for the candidate project to increase above the training threshold.

16. The learning management system of claim 9, wherein the analytics engine is further configured to determine training plans for a plurality of employees of the organization, wherein determining the training plans includes selecting a plurality of training courses based on learning effectiveness scores and wherein the marginal benefit analysis indicates that adding the plurality of training courses results in a specified marginal success rate increase.

17. A tangible, nontransitory computer-readable medium storing a computer program, wherein the computer program, when executed by one or more computers, causes the one or more computers to perform a method for conducting training in an organization, the method comprising:
identifying a candidate project in the organization, wherein identifying the candidate project includes determining that the candidate project is at risk and that a level of training for the candidate project is below a training threshold;
conducting, by one or more processors, a marginal benefit analysis including determining a marginal success rate increase as a function of a training level increase;
conducting, by the one or more processors, a learning effectiveness analysis including determining a plurality of effectiveness scores and a plurality of cost values corresponding to a plurality of training courses;
determining a training plan for an employee of the organization based on the marginal benefit analysis and the learning effectiveness analysis; and
delivering the training plan.

18. The nontransitory computer readable medium of claim 17, wherein the method further includes determining the training threshold comprising:
collecting success rates of a plurality of prior projects;
collecting a plurality of training levels at the prior projects; and
analyzing a correlation between the success rates and the training levels, wherein for a subset of the plurality of prior projects with training levels below the training threshold, the corresponding success rates are below a success threshold.

19. The nontransitory computer readable medium of claim 17, wherein determining an effectiveness score for a training course comprises determining an impact of the training course on at least one of employee performance, employee proficiency level, employee retention, employee promotion, employee utilization, employee satisfaction, or project success.

20. The nontransitory computer readable medium of claim 17, wherein the method further includes determining training plans for a plurality of employees of the organization, wherein determining the training plans includes selecting a plurality of training courses based on learning effectiveness scores and wherein the marginal benefit analysis indicates that adding the plurality of training courses results in a specified marginal success rate increase.
